(19) United States
(12) Patent Application Publication
(10) Pub. No.: US 2010/0299120 A1
(43) Pub. Date: Nov. 25, 2010

(54) SYSTEM AND METHOD FOR THE COMBINED ACQUISITION OF DATA FOR SCADA AND SIMULATION OR NETWORK CALCULATION APPLICATIONS

(75) Inventor: Bardolf Engel, Fussgoenheim (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/789,939

(22) Filed: May 28, 2010

Related U.S. Application Data
(63) Continuation of application No. PCT/EP2008/009902, filed on Nov. 21, 2008.

(30) Foreign Application Priority Data
Nov. 29, 2007 (DE) 10 2007 057 871.9

(51) Int. Cl. G06G 7/48

(52) U.S. Cl. 703/6

(57) ABSTRACT

A system and method are provided for the combined acquisition of data for SCADA and simulation or network calculation applications. At least one data processing device has means for generating templates and acquiring data. The means allows at least two model levels of a supply network (e.g., a gas network) to be generated on the basis of a template and/or pattern in cooperation with at least one data memory. At least one consistent generic template contains a uniform, consistent pattern for a detailed model of at least one first model level, for a simplified model of at least one second model level, and/or respective conversion instructions, such as for the transition between at least two respective model levels, to be established and/or retrieved for recurring subareas and/or object groups and/or objects of the at least two model levels. The respective generic template can be copied, and the respective generic template can be individually adjusted, and/or concrete subareas of both model levels can be combined.

### RELATED APPLICATIONS

This application claims priority as a continuation application under 35 U.S.C. §120 to PCT/EP2008/009902, which was filed as an International Application on Nov. 21, 2008 designating the U.S., and which claims priority to German Application 10 2007 057 871.9 filed in Germany on Nov. 29, 2007. The entire contents of these applications are hereby incorporated by reference in their entireties.

### FIELD

The present disclosure relates to a system and a method for the combined acquisition of information for SCADA and network calculation applications or simulation applications, such as for gas, water or district heating supply networks, for example.

Detailed models of the respective network and especially of the devices in the various stations of the network are used in network management systems, such as in gas networks, for monitoring, control and information or data acquisition (also referred to as Supervisory, Control and Data Acquisition (SCADA)). In contrast, however, the respectively used simulation and/or network calculation programs use simplified models in which, for example, a plurality of physical devices are combined to form so-called logical devices. In order to be able to transfer the online data from the SCADA system to the respective simulation and/or network calculation application, these logical, virtual devices must first of all be generated (calculated) in the SCADA system. Under certain circumstances, it is likewise necessary to divide the results achieved among a plurality of real measuring points for display. All of these models, that is to say both the detailed model and the simplified model, as well as the instructions and computing rules in SCADA which are needed to generate the model can be acquired by means of individual data input and parameterization.

Accordingly, the underlying models and/or the models which describe or depict the network in the respective application and/or the objects to be combined in a corresponding manner, such as field devices, actuators or final controlling elements (e.g., drives, pumps or else valves, sensors or detectors, switching devices, programmable logic controllers (PLC) and the like) are conventionally acquired individually and independently of one another. This gives rise to a comparatively high level of complexity and involves the risk that, if at least one of the two models or subareas of the model(s) is/are acquired for the first time or reacquired and/or changed, inconsistencies in the information or data stock of the two models or model levels may occur as a result of different inputs/acquisition processes. Inconsistencies mean that not all required detailed information is acquired in the superordinate model, or contradictory or opposing information is acquired. These inconsistencies may lead to result corruption or incorrect results and/or may trigger malfunctions during online operation.

### SUMMARY

An exemplary embodiment provides a system for the combined acquisition of information for SCADA and simulation or network calculation applications. The exemplary system includes at least one data memory, and at least one data processing device having means for generating templates and for acquiring information. The means, in cooperation with at least one data memory, is configured to generate at least two model levels of a supply network, on the basis of at least one of templates and patterns, and generate at least one consistent generic template by at least one of creating and calling up the at least one consistent generic template via template generation for repeating at least one of subareas, object groups and objects of the at least two model levels. The means is configured to generate the at least one consistent generic teample so that the generic template respectively at least one of (i) includes a uniform consistent pattern for a detailed model of at least one first model level, for a simplified model of at least one of a second model level and respective conversion details, including for the transition between at least two respective model levels, (ii) is configured to copied, (iii) is configured to be individually adapted, and (iv) enables specific subareas of the two model levels to be combined.

An exemplary embodiment provides a method for the combined acquisition of information for SCADA and simulation or network calculation applications. The exemplary method includes: generating, in at least one data processing device, templates for acquiring information; generating, in the at least one data processing device, at least two model levels of a supply network, on the basis of at least one of templates and patterns; and generating, in the at least one data processing device, at least one consistent generic template by at least one of creating and calling up the at least one consistent generic template via template generation for repeating at least one of subareas, object groups and objects of the at least two model levels. The generation of the at least one consistent generic template comprises generating the at least one generic template so that the at least one generic template at least one of (i) includes a uniform consistent pattern for a detailed model of at least one first model level, for a simplified model of at least one of a second model level and respective conversion details, including for the transition between at least two respective model levels, (ii) is configured to copied, (iii) is configured to be individually adapted, and (iv) enables specific subareas of the two model levels to be combined.

### BRIEF DESCRIPTION OF THE DRAWINGS

Additional refinements, advantages and features of the present disclosure are described in more detail below with reference to exemplary embodiments illustrated in the drawings, in which:

FIG. 1 shows an exemplary system for executing the method for the combined acquisition of information for SCADA and simulation or network calculation applications for a gas network; and

FIG. 2 shows an exemplary subarea and an exemplary object group of a first model level and the correspondingly combined or simplified model of a second model level.

### DETAILED DESCRIPTION

Exemplary embodiments of the present disclosure provide a system and method which enable improved and more efficient information acquisition, for example, with regard to improved consistency of the acquired information, in SCADA and simulation or network calculation applications.

Exemplary embodiments of the present disclosure provide a system and method for the combined acquisition of information for SCADA and simulation or network calculation applications. The system includes at least one data processing device which has means for generating templates and for acquiring information. The means can be used, in cooperation with at least one data memory, to generate at least two model levels of a supply network (e.g., of a gas, water or district heating network), on the basis of templates and/or patterns. At least one consistent generic template respectively can be respectively created and/or called up by means of template generation for repeating subareas and/or object groups and/or objects of the at least two model levels. The generic template includes a uniform consistent pattern for a detailed model of at least one first model level, for a simplified or combined model of at least one second model level and/or respective conversion details, such as for the transition between at least two respective model levels, and/or the respective generic template being able to be copied, the respective generic template is able to be individually adapted by means of information acquisition, and/or specific subareas of the two model levels are able to be combined.

In one advantageous development, the conversion details can include conversion parameters, calculation rules, transition rules, conversion instructions, combination rules, dependencies, topological relationships, and/or plausibility rules. For example, the above-mentioned conversion details may include mathematical operators and functions which include addition, subtraction, division, summation, weighted sum, weightings and/or averaging or else logical operators, such as those from Boolean algebra in the form AND, OR, NOT, for example.

More complex combinations can also be implemented in this case, for example in the form: if valve 1 in line 1 is in the open state and valve 2 in line 2 is in the open state, where line 1 and line 2 are parallel branches, then determine the average temperature from the two lines. However, if valve 1 in line 1 is in the open state and valve 2 in line 2 is in the closed state, then determine the average temperature only using the temperature from line 1.

The above-mentioned simplified example can also be carried out for other physical variables, such as variables which can be measured, for example flow rate, pressure and the like, and for more than two lines.

Another exemplary embodiment provides for the generic and/or adapted templates and/or associated patterns and/or specified subareas or objects to be able to be stored in a data memory set up for this purpose, for example in at least one appropriately configured database, in such a manner that they can be accessed and retrieved.

In another exemplary embodiment, the respective generic template and its associated pattern can include at least one mask for manually acquiring and/or adapting information or data.

For example, the respective information can be acquired manually and/or can be acquired in automated fashion online using at least one communication link, for example when accessing a corresponding control system and device information, such as sensor and state information.

In another exemplary embodiment, at least one checking means is advantageously provided to perform a plausibility check on the respective template and associated patterns and/or on the specific subareas of the first and/or second model level in a rule-based manner, by using plausibility rules, for example, when accessing conversion details.

A plausibility check makes it possible to check a value or generally a result using a rough calculation in order to determine whether it appears to be plausible, that is to say whether it is acceptable, reasonable and comprehensible.

For example, lower threshold values or average values can be predefined for at least one characteristic variable or physical variable of the individual line branches of the first model level, which values must not be undershot when determining an average characteristic variable value in the combined model of the second model level. The temperature, flow rate, pressure and the like can be used in this case as the characteristic variable.

For example, in the event of changes in the detailed area, it is advantageously possible to check whether the respective change can affect the overall modeling.

For example, it is possible to check in this manner whether a logical, virtual valve in the simplified model also includes all individual valves of particular types in the detailed model or in the detailed modeling.

It goes without saying that a corresponding situation also applies to other objects and/or object groups.

In another exemplary embodiment, at least one indication means can be advantageously provided to indicate possible inconsistencies and/or incorrect acquisition processes and/or incorrect details if the plausibility check is negative. For example, the indication means can generate and output a corresponding message, for example by means of a dialog query and possibly also with an acknowledgement function. The indication means permits the respective template and/or patterns from being left (e.g., maintained) and/or stored by temporarily blocking the respective template and/or the associated patterns and, for example, the maintenance and/or storage can thereafter be permitted following express confirmation and/or acknowledgement.

According to an exemplary embodiment, the combined model of the second model level can be automatically generated when accessing and using topological relationships and/or plausibility rules, a request to complete the information being issued if the details are incomplete.

Exemplary embodiments of the present disclosure also provide a corresponding method for the combined acquisition of information for SCADA and simulation or network calculation applications, such as for execution in the abovementioned system, at least two model levels of a supply network (e.g., a gas, water or district heating network), being gradually generated on the basis of templates and/or patterns by respectively creating and/or calling up at least one consistent generic template for repeating subareas and/or object groups and/or objects of the at least two model levels. The generic template can include a uniform consistent pattern for a detailed model of at least one first model level, for a simplified or combined model of at least one second model level and/or respective conversion details, such as for the transition between at least two respective model levels, and/or the respective generic template being copied (e.g., duplicated), and individually adapted, and/or specific subareas of the two model levels being combined.

In one advantageous development, conversion parameters, calculation and/or transition rules, conversion instructions, combination rules, dependencies, topological relationships and/or plausibility rules can be used as conversion details. For example, the above-mentioned conversion details can include mathematical operators and functions which include addition, subtraction, division, summation, weighted sum, weightings and/or averaging or else logical operators, such as those from Boolean algebra in the form AND, OR, NOT, for example.

For example, more complex combinations can also be advantageously implemented and used according to the above-mentioned system, such as with regard to numerous and different physical measurement variables.

Provision can also be made for the generic and/or adapted templates and/or associated patterns and/or specified subareas to be stored in a data memory set up for this purpose, such as in at least one appropriately configured database, in such a manner that they can be accessed and retrieved.

In one advantageous development of the method, the respective generic template and its associated pattern provide at least one mask for manually acquiring and/or adapting information or data.

For example, the respective information can be acquired manually and/or can be acquired in automated fashion online using at least one communication link, for example when accessing a corresponding control system and device and/or operating equipment information, in particular sensor and state information.

In an advantageous embodiment, a plausibility check is performed on the respective template and the associated patterns and/or on the specific subareas in a rule-based manner, such as by using plausibility rules, when accessing conversion details, in which case, for example, in the event of changes in the detailed area, it is advantageously possible to check whether the respective change can affect the overall modeling, with the result that it is possible to check, for example, whether a logical, virtual object or an object group in the simplified model also comprises all associated individual objects in the detailed model or in the detailed modeling.

In another exemplary embodiment, lower threshold values or average values, for example, can also be predefined for at least one characteristic variable or physical variable of the individual line branches of the first model level, which values must not be undershot when determining an average characteristic variable value in the combined model of the second model level. The temperature, flow rate, pressure and the like can be used, in particular, in this case as the characteristic variable.

The exemplary method can also provide for possible inconsistencies and/or incorrect acquisition processes and/or incorrect details to be indicated and/or for attention to be drawn thereto if the plausibility check is negative, such as by generating a corresponding message, for example by means of a dialog query and possibly also with an acknowledgement function, and/or by temporarily blocking the respective template and/or the associated patterns, with the result that the respective template and/or patterns can be prevented from being left (e.g., maintained) and/or stored, and the maintenance and/or storage can follow express confirmation or acknowledgement.

The respectively combined model of the second model level can be generated automatically when accessing and using topological relationships and/or plausibility rules, a request to complete and/or correct the respective information being issued if the details are incomplete and/or contain errors.

Exemplary embodiments of the present disclosure are described further and explained with reference to the drawings.

Advantageous refinements and developments of the disclosure are specified in the cited figures and the associated exemplary embodiments.

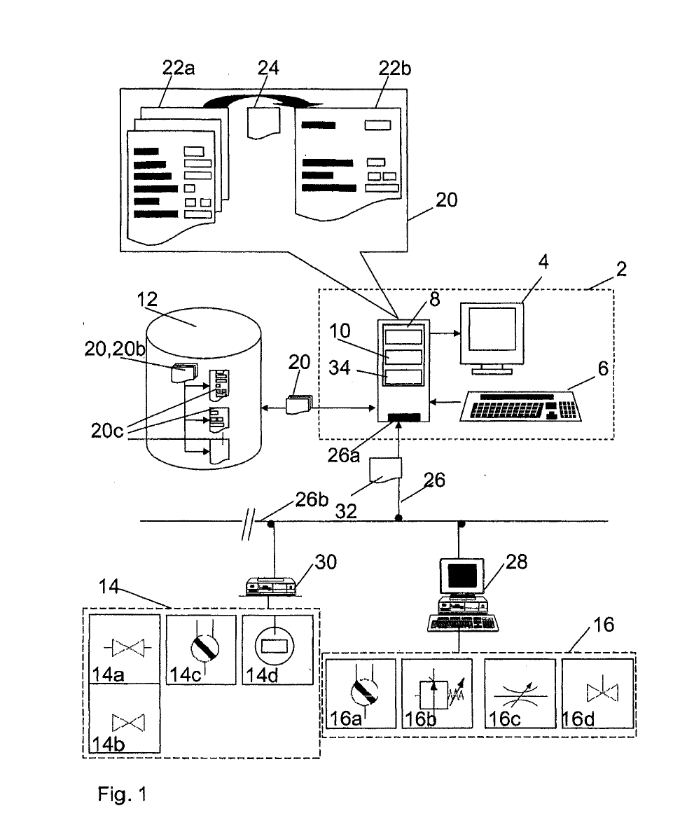

FIG. 1 shows an exemplary system for executing the method for the combined acquisition of information for SCADA and simulation or network calculation applications for a gas network. The system has a data processing device 2 with a display device 4 and an input device 6. In the example of FIG. 1, the display device 4 and the input device 6 are illustrated in the form of a monitor and a keyboard, respectively, although the present disclosure is not limited to this example. According to an exemplary embodiment, the data processing device 2 can include at least one processor (e.g., ARM processor, ASIC (application specific integrated circuit) and/or other suitable processing circuitry) which can execute computer-readable instructions and/or a computer program recorded on a computer-readable recording medium (e.g., a non-volatile memory such as a ROM (read only memory), flash drive, optical memory, etc.) to carry out the functions and features of the exemplary embodiments described herein. In the following description of exemplary embodiments of the present disclosure, the processor included in the data processing device 2 is an example of at least a constitutent part of one or more means for performing various functions and features as described herein. For example, according to an exemplary embodiment, the processor included in the data processing device 2 can constitute a means for generating templates 8 and for acquiring or processing information 10, where such means are used, in cooperation with a data memory 12, to generate at least two model levels of a supply network (e.g., of a gas, water or power supply network), on the basis of templates and/or patterns. At least one consistent generic template 20 is respectively created and/or called up from a data memory 12 in accordance with a template generation for repeating subareas and/or object groups 14, 16 and/or objects of the at least two model levels, which may be, for example, valves 14a, 14b, 16d, position indicators 14c, 16a, a measuring device 14d (e.g., a flowmeter), a throttle valve 16c, pressure control valves 16b, sensors or measuring sensors and the like. According to an exemplary embodiment, the generic template can include a uniform consistent pattern for a detailed model 22a of the first model level, for a simplified model 22b of the second model level and/or respective conversion details 24. The respective generic template 20 can also be copied (e.g., duplicated) in order to reduce or minimize the input complexity or acquisition complexity and thereby reduce or minimize possible acquisition and/or input errors. The respective generic template 20 can be personalized or individually conditioned and/or adapted by adapting or modifying data or information which is already included and/or adding new or further information, specific subareas of the two model levels being able to be combined.

The objects, object groups and/or subareas of the different model levels can each be illustrated in this case in the form of a list and/or graphically in the form of pictograms with further stored object information and/or specifics relating to the objects, object groups and/or subareas of the different model levels.

According to an exemplary embodiment, the conversion details 24 used for the transition between the two model levels or to determine the logical objects can include conversion parameters, calculation rules, conversion instructions, combination rules, dependencies, topological relationships, and/or plausibility rules.

Furthermore, the generic template(s) 20, adapted templates, associated patterns, and/or specified subareas can be stored or can have been stored in a data memory 12 set up for this purpose (e.g., in at least one appropriately configured database), in such a manner that they can be accessed and retrieved.

The respective generic template 20 and its at least one associated pattern 20b can have at least one input mask 20c for manually acquiring and/or adapting information or data.

According to an exemplary embodiment, the respective information can be acquired manually and/or can be acquired in automated fashion online and/or in real time using at least one communication link 26, such as an interface 26a with a coupled bus system 26b, for example of the field bus, Profibus, Modbus, Ethernet, Bluetooth, WLAN, LAN, WAN, SCSI, PCI, USB or RS-232 type or a combination thereof, for example when accessing a corresponding control system, MES (Manufacturing Execution System), process control system or network control system 28 which may have, for example, objects 14a, b, c, d or object groups 14 which are managed by means of one or more programmable logic controllers 30 (PLC) or directly managed objects or object groups 16. Specific device information or operating equipment information 32 relating to objects which are arranged or installed in the respective supply network (a gas network in the example shown here), for example actuators or final controlling elements (e.g., valves, throttle valves, pressure controllers, position indicators, measuring and/or counting devices), as well as sensor and state information can therefore also be advantageously acquired.

The system also has at least one checking means 34 (e.g., the processor included in the data processing device 2) which carries out a plausibility check and/or consistency check on the respective template and associated patterns and/or on the specific subareas when accessing conversion details 24 stored in the data memory 12, such as plausibility rules, for example. Accordingly, changes in the detailed area can be checked in order to determine whether the respective change can affect the overall modeling.

If the check is positive, the created templates, their patterns and/or the respectively specified subareas are consistent and can be stored in a data memory 12 in such a manner that they can be retrieved. The two model levels 22a, 22b required are therefore formed consistently and can be used as a basis for the respective application and further processing.

However, if the check is negative, an indication means is used to indicate possible inconsistencies, incorrect acquisition processes, and/or incorrect details. For example, the indication means can generate and output a corresponding message, for example by means of a dialog query and possibly also with an acknowledgement function. and/or by temporarily blocking the respective template and/or the associated. In addition, blocking functionalities, which first of all prevent the respective template, pattern and/or mask from being left and/or stored and, for example, allow the respective method to be continued and/or concluded only after express confirmation or acknowledgement, may be provided.

Furthermore, the combined model of the second model level can also be automatically generated when accessing and using topological relationships and/or plausibility rules, where a request to complete the information is issued if the details are incomplete.

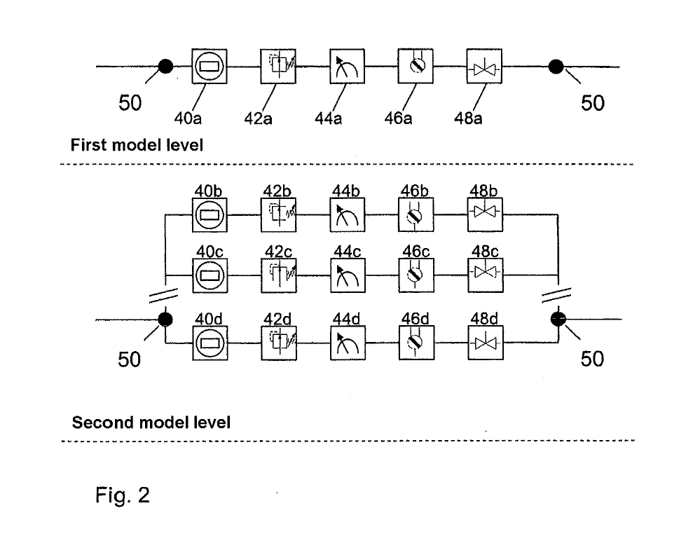

FIG. 2 shows an exemplary subarea 36 of a first model level, having at least three line branches 38b, c, d of a gas network which are arranged between two branching points 50 and have corresponding object groups b, c, d each with five individual objects 40b, 42b, 44b, 46b, 48b and 40c, 42c, 44c, 46c, 48c and 40d, 42d, 44d, 46d, 48d. In the example of FIG. 2, the respective objects are flowmeters 40b, c, d, pressure control valves 42b, c, d, temperature meters 44b, c, d, position indicators 46b, c, d and valves 48b, c, d.

This model of the first model level containing objects 50, 40b, c, d-48b, c, d and object groups b, c, d of the first model level is now converted, according to the method and system (e.g., by the processor included in the data processing device 2), into a simplified combined model of the second model level by using conversion details to combine the subarea 36, including the object groups b, c, d and the objects 40-48b, c, d of the first model level, to form a simplified model of the second model level 36a using the respective consistent generic template 20 which can be called up from a data memory 12. According to the illustrated example of FIG. 2, the simplified model would have only 7 objects 50, 40-48a instead of the originally at least 17 objects 40-48b, c, d for the subarea.

In this example, the simplified combined model for this subarea 36a also comprises a flowmeter 40a, a pressure control valve 42a, a temperature meter 44a, a position indicator 46a and a valve 48a.

By way of example, the following conversion details 24, conversion parameters, calculation rules, conversion instructions, combination rules, dependencies, topological relationships, and/or plausibility rules can be used.
a) The flow rate indicated by the flowmeter 40a of the second model level can be formed from the sum of the flows (flow rates) determined by the flowmeters 40b, c, d in the different branches of the first model level and can thus indicate the total flow rate between the branching points.
b) Furthermore, the pressure control valve 42a of the second model level could indicate the average pressure of the three individual pressure control valves 42b, c, d, in which case it is taken into account the measurement data only from those pressure control valves 42b, c, d in which the corresponding valve 48b, c, d of their object group b, c, d is also open and a flow is thus possible in the first place.
c) The temperature with regard to an average temperature in the second model level also appears to be of interest and useful only in light of those temperature meters 44b, c, d of the first model level whose associated valves 48b, c, d of the respective object group are also actually open and through whose branches the respective medium can also flow. This means that, for example, the sum of the measured temperatures of the individual open branches divided by the number of open branches or temperature meters of the first model level reveals the temperature of the temperature meter 44a of the second model level.
d) Furthermore, the state of the valve 48a of the second model level should already indicate “open” if only one of the valves 48b, c, d is in the open state.
e) In contrast, the position indicator 46a of the second model level may indicate the percentage valve position or opening of the valves of the first model level.

A plausibility check can be carried out, for example, to the effect that a check is carried out in order to determine whether the number of elements in a summation corresponds to the number of respective objects of an object type and/or whether all objects of an object type, for example a valve or a temperature meter or a flowmeter, of a subarea of the first model level have actually been taken into account or included in the corresponding subarea of the second model level, for example, when using the conversion details.

It is likewise possible to check whether the respective object group structure or subarea structure of the first model level has been correctly reproduced in the second model level.

The above-mentioned list should not be considered to be conclusive by any means and is not intended to restrict the present disclosure. Rather, it is used for illustration purposes. In principle, any desired conversion details can be freely predefined, on the basis of the respective field of application, for example.

The different templates and masks which can be used and/or called up and the objects and object groups having them can also be freely predefined and/or can also be individually coupled and combined using conversion rules which have been adapted to the individual situation or the respective application.

It is pointed out that the method and system can be used, in principle, for all networks having flowing media, such as gas, water and district heating networks, but also, for example, for refineries, oil pipelines, the chemical/pharmaceutical industry and its raw materials and supply networks.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for the combined acquisition of information for SCADA and simulation or network calculation applications, the system comprising:
at least one data memory; and
at least one data processing device having means for generating templates and for acquiring information,
wherein the means, in cooperation with at least one data memory, is configured to
generate at least two model levels of a supply network, on the basis of at least one of templates and patterns,
generate at least one consistent generic template by at least one of creating and calling up the at least one consistent generic template via template generation for repeating at least one of subareas, object groups and objects of the at least two model levels, and
wherein the means is configured to generate the at least one consistent generic template so that the generic template respectively at least one of (i) includes a uniform consistent pattern for a detailed model of at least one first model level, for a simplified model of at least one of a second model level and respective conversion details, including for the transition between at least two respective model levels, and/or (ii) is configured to be copied, (iii) is configured to be individually adapted, and/or (iv) enables specific subareas of the two model levels to be combined.

2. The system as claimed in claim 1, wherein the conversion details comprise at least one of conversion parameters, calculation rules, conversion instructions, combination rules, dependencies, topological relationships, and plausibility rules.

3. The system as claimed in claim 1, wherein the respective generic template and its associated pattern comprise at least one mask for at least one of manually acquiring and adapting information or data.

4. The system as claimed in claim 1, wherein the means is configured to facilitate acquisition of respective information at least one of manually and in an automated fashion online via at least one communication link.

5. The system as claimed in claim 1, comprising:
checking means configured to perform a plausibility check on at least one of the respective template and its associated pattern, and the specific subareas in a rule-based manner.

6. The system as claimed in claim 5, wherein, in the event of changes in a detailed area of the at least one generic template, the checking means is configured to check whether the change affects at least one of overall modeling of the supply network, and modeling of a combination of the respective second model level.

7. The system as claimed in claim 5, comprising:
indication means configured to indicate at least one of possible inconsistencies, incorrect acquisition processes, and incorrect details if the plausibility check is negative.

8. The system as claimed in claim 7, wherein the indication means is configured to at least one of generate and display a message if the plausibility check is negative.

9. The system as claimed in claim 7, wherein, if the plausibility check is negative, the indication means prevents at least one of the respective template its patterns from at least one of being maintained and stored by temporarily blocking the at least one of the respective template and its associated patterns.

10. The system as claimed in claim 1, wherein the means automatically generates a combination of the model of the respective second model level when at least one of accessing and using at least one of topological relationships and plausibility rules, and a request to complete the information is issued if details thereof are incomplete.

11. A method for the combined acquisition of information for SCADA and simulation or network calculation applications, the method comprising:
generating, in at least one data processing device, templates for acquiring information;
generating, in the at least one data processing device, at least two model levels of a supply network, on the basis of at least one of templates and patterns; and
generating, in the at least one data processing device, at least one consistent generic template by at least one of creating and calling up the at least one consistent generic template via template generation for repeating at least one of subareas, object groups and objects of the at least two model levels,
wherein the generation of the at least one consistent generic template comprises generating the at least one generic template so that the at least one generic template at least one of (i) includes a uniform consistent pattern for a detailed model of at least one first model level, for a simplified model of at least one of a second model level and respective conversion details, including for the transition between at least two respective model levels, (ii) is configured to copied, (iii) is configured to be individually adapted, and (iv) enables specific subareas of the two model levels to be combined.

12. The method as claimed in claim 11, wherein the conversion details include at least one of conversion parameters, calculation rules, conversion instructions, combination rules, dependencies, topological relationships, and plausibility rules.

13. The method as claimed in claim 11, wherein the respective generic template and its associated pattern provide at least one mask for at least one of manually acquiring and adapting information or data.

14. The method as claimed in claim 11, wherein the respective information is at least one of acquired manually, acquired in an automated fashion, acquired online, and acquired in real time using at least one communication link.

15. The method as claimed in claim 11, comprising performing a plausibility check on at least one of the respective template and its associated patterns, and the specific subareas in a rule-based manner, using plausibility rules, when accessing conversion details, so that, in the event of changes in a detailed area of the at least one respective template, it is determined whether the respective change affects overall modeling of at least one of the at least two model levels, and modeling of a combination of the model of the respective second model level.

16. The method as claimed in claim 15, comprising indicating at least one of possible inconsistencies, incorrect acquisition processes, and incorrect details to draw attention thereto if the plausibility check is negative.

17. The method as claimed in claim 15, comprising generating and outputting a corresponding message, which comprises at least one of a dialog query and an acknowledgement function, if the plausibility check is negative.

18. The method as claimed in claim 15, comprising, if the plausibility check is negative, temporarily blocking at least one of the respective template and its associated pattern, so that at least one of the respective template and its patterns are prevented from being maintained or stored.

19. The method as claimed in claim 11, comprising automatically generating the respectively combined model of the respective second model level when at least one of accessing and using at least one of topological relationships and plausibility rules, and a request to at least one of complete and correct the respective information is issued if details thereof are at least one of incomplete and contain errors.

20. The system as claimed in claim 1, wherein the means is a processor comprised in the data processing device.

21. The system as claimed in claim 2, wherein the respective generic template and its associated pattern comprise at least one mask for at least one of manually acquiring and adapting information or data.

22. The system as claimed in claim 4, wherein the means facilitates acquisition of the respective information when accessing at least one of a corresponding control system and device information.

23. The system as claimed in claim 5, wherein the checking means is configured to perform the plausibility check using plausibility rules, when accessing conversion details.

24. The system as claimed in claim 8, wherein the message is at least one of generated and displayed with at least one of a dialog query and an acknowledgement function.

25. The system as claimed in claim 6, comprising:
indication means configured to indicate at least one of possible inconsistencies, incorrect acquisition processes, and incorrect details if the plausibility check is negative.

26. The system as claimed in claim 25, wherein the indication means is configured to at least one of generate and display a message if the plausibility check is negative.

27. The system as claimed in claim 26, wherein the message is at least one of generated and displayed with at least one of a dialog query and an acknowledgement function.

28. The system as claimed in claim 9, wherein the indication means enables at least one of maintenance and storage of the at least one of the respective template its patterns following at least one of express confirmation and acknowledgement by an operator of the data processing device.

29. The system as claimed in claim 8, wherein, if the plausibility check is negative, the indication means prevents at least one of the respective template its patterns from at least one of being maintained and stored by temporarily blocking the at least one of the respective template and its associated patterns, and
wherein the indication means enables at least one of maintenance and storage of the at least one of the respective template its patterns following at least one of express confirmation and acknowledgement by an operator of the data processing device.

30. The method as claimed in claim 14, wherein the respective information is acquired when accessing at least one of a corresponding control system and device information.

31. The method as claimed in claim 17, comprising enabling at least one of maintenance and storage of the at least one of the respective template its patterns following at least one of express confirmation and acknowledgement by an operator of the data processing device.
